(19) United States
(12) Patent Application Publication
(10) Pub. No.: US 2009/0075668 A1
(43) Pub. Date: Mar. 19, 2009

(54) Method of indicating packet waiting time in wireless packet data systems

(76) Inventor: Anil M. Rao, Cedar Knolls, NJ (US)

Correspondence Address: Docket Administrator - Room 2F-192;Alcatel-Lucent USA Inc., 600-700 Mountain Avenue, Murray Hill, NJ, 07974, US

(21) Appl. No.: 11/901,028

(22) Filed: Sep. 14, 2007

(51) Int. Cl. H04Q 7/20; H04J 3/00

(52) U.S. Cl. 455/452.2; 370/252; 370/336; 455/509

(57) ABSTRACT

The present invention provides a method for indicating packet waiting time in wireless packet data systems. A mobile unit determines a packet waiting time measurement of an amount of time that a data packet has been waiting in a buffer of a mobile unit. The mobile unit then transmits the packet waiting time measurement to a base station.

### FIELD OF THE INVENTION

The present invention relates generally to wireless communication systems, and more particularly to the transmission of data between a base station and a mobile station in a wireless communication system.

### BACKGROUND OF THE INVENTION

In wireless communication systems, base stations transmit data to mobile stations. In many current wireless communication systems, a mobile unit must wait for permission from the base station prior to sending data to the base station.

When a mobile unit has no valid resource assignment from the base station scheduler for its data channel, the mobile unit must first send a Scheduling Request (SR) to the base station and receive permission to transmit its data on an orthogonal resource allocated by the base station scheduler. The SR can be sent via a random access channel (RACH) which is a contention-based channel shared by many mobile units or the SR can be sent on a Dedicated CHannel (DCH), which is an orthogonal channel designated to be used by a particular mobile at a particular time. Sending the SR on the RACH can result in much longer delay to get the SR through.

In both the RACH and DCH cases, the opportunity to send the SR is only provided at certain time instances. This may be as large as 10 ms to 20 ms for the RACH and as long as 5 ms to 10 ms for the DCH. In both cases, it is possible that the SR is not received properly on the first transmission attempt by the mobile unit. In the case of RACH this may be due to collision with another user. In the case of DCH it may be due to an error in decoding the SR due to poor RF channel conditions.

The typical steps involved in a mobile unit sending its SR subsequent to its data traffic is as follows. Data arrives in a buffer within the mobile unit. The mobile unit waits for the next available RACH or DCH opportunity to send its SR. If the RACH or DCH opportunities are provided every 10 milliseconds, the maximum delay will be 10 milliseconds for this step.

The mobile unit then sends the SR to the base station. The SR notifies the base station that the mobile unit would like to start data transmission. The mobile unit will continue to send SR at each provided opportunity until it receives an acknowledgement in the form of a scheduling grant from the base station.

If the base station detects the SR from the mobile unit, the base station sends an acknowledgement to the mobile unit in the form of a scheduling grant. The scheduling grant gives the mobile unit air interface resources on which it can transmit its scheduling information (SI) and data.

The mobile unit receives the scheduling grant from the base station containing the assigned resource to transmit. Depending on the size of the resource granted, the mobile unit may transmit the SI alone, or the SI along with some of the data in the buffer. There may be errors in decoding the scheduling grant from the base station due to poor RF channel conditions, in which case the mobile unit will again send the SR at the next opportunity.

The time from when the data arrives in the mobile buffer to the time that the data is actually transmitted to the base station can be highly variable. The actual time it takes depends on a number of factors, including the frequency with which the RACH or DCH are provided for the transmission of the SR, erroneous decoding of the SR by the base station due to possible collisions between multiple users on the RACH or poor RF channel conditions on the DCH, and erroneous decoding at the mobile unit of the scheduling grant sent by the base station due to poor RF channel conditions.

Given the large number of factors which can influence the time it takes for the mobile unit to finally send the SI and data, the amount of time the data waits in the mobile unit buffer is estimated to range from a few milliseconds to as large as 50 to 60 ms. The amount of time the data is waiting in the mobile buffer before transmission begins is unknown to the base station; hence the base station scheduler is unable to make intelligent decisions on further scheduling grants for this mobile unit. The base station scheduler is also not able to intelligently prioritize scheduling of other mobile units based on latency.

### BRIEF SUMMARY OF THE INVENTION

The present invention provides a solution to the problems of the prior art by transmitting a latency indicator for each data flow that the network configures to report a latency indicator. In a first exemplary embodiment, a mobile unit includes the latency indicator in the Scheduling Information (SI). In a second exemplary embodiment, the mobile unit includes the latency indicator as part of the MAC header of each scheduled data packet from the mobile unit.

In accordance with an exemplary embodiment of the present invention, the mobile unit makes a measurement on the amount of time the oldest unacknowledged data packet has been waiting in a buffer in the mobile unit. This measurement is preferably used to set the latency indicator.

The latency indicator itself can take on different forms; it can either be conveyed using several bits to correspond to an actual delay, which is measured in some unit of time. The units of time can be milliseconds, number of slots, or any other suitable measurement of time. The latency indicator can alternately be a single bit which is set to true if the oldest packet has been waiting in the mobile unit buffer beyond a preconfigured delay threshold.

The present invention thereby provides an indication to the base station scheduler regarding the amount of time that a data packet has been waiting in the buffer of the mobile unit. The indicator significantly improves the base station scheduler's ability to intelligently assign resources to data flows carrying latency sensitive information, as well as increase the throughput for best effort applications by allowing the scheduler to attempt to maintain a short round-trip time.

Further, the present invention provides a great benefit in VoIP situations. By alerting the base station of when an initial VoIP packet arrived in the mobile unit buffer, the base station can calculate when subsequent VoIP packets will arrive in the mobile unit buffer, since VoIP frames arrive 20 ms apart with typical vocoders. The base station can then pre-allocate resources at the proper time instances in the future to align with the arrival rate of VoIP packets at the mobile unit, thereby provided greater reliability and less delay in VoIP systems.

### BRIEF DESCRIPTION OF THE SEVERAL VIEWS OF THE DRAWINGS

FIG. 1 depicts a flowchart of a method for transmitting a packet waiting time measurement from a mobile unit to a base station utilizing a latency indicator bit in accordance with an exemplary embodiment of the present invention.

FIG. 2 depicts a representation of a MAC packet in accordance with an exemplary embodiment of the present invention.

FIG. 3 depicts a flowchart of a method for transmitting a packet waiting time measurement from a mobile unit to a base station using latency indicator bits in accordance with an exemplary embodiment of the present invention.

FIG. 4 depicts a table of representative latency indicator bits and delay values in accordance with an exemplary embodiment of the present invention.

### DETAILED DESCRIPTION OF THE INVENTION

In a first exemplary embodiment, the latency indicator indicates whether the packet waiting time has exceeded a pre-configured delay threshold. In a second exemplary embodiment, the latency indicator conveys an absolute latency indication of the packet waiting time.

In a first exemplary embodiment, the latency indicator for each data flow configured to report a latency indicator is carried as part of the scheduling information (SI) that is sent by the mobile unit to the base station. The SI is expected to be sent by the mobile unit following the scheduling request (SR). The SI is typically configured by the network to be sent from the mobile unit to the base station periodically, for example, every 100 ms.

The latency indicator for a data flow provides an indication as to the amount of time that one or more data packets have been waiting in the mobile unit's buffer. In accordance with an exemplary embodiment, the latency indicator provides an indication of latency for the oldest packet in the mobile buffer which has not been acknowledged to have been received by the base station. The measurement of the amount of time that one or more packets have been waiting in the mobile unit's buffer can be referred to as the “packet waiting time”. The acknowledgement from the base station is preferably provided in the form of an ACK or NACK as is customary in most scheduled packet data systems.

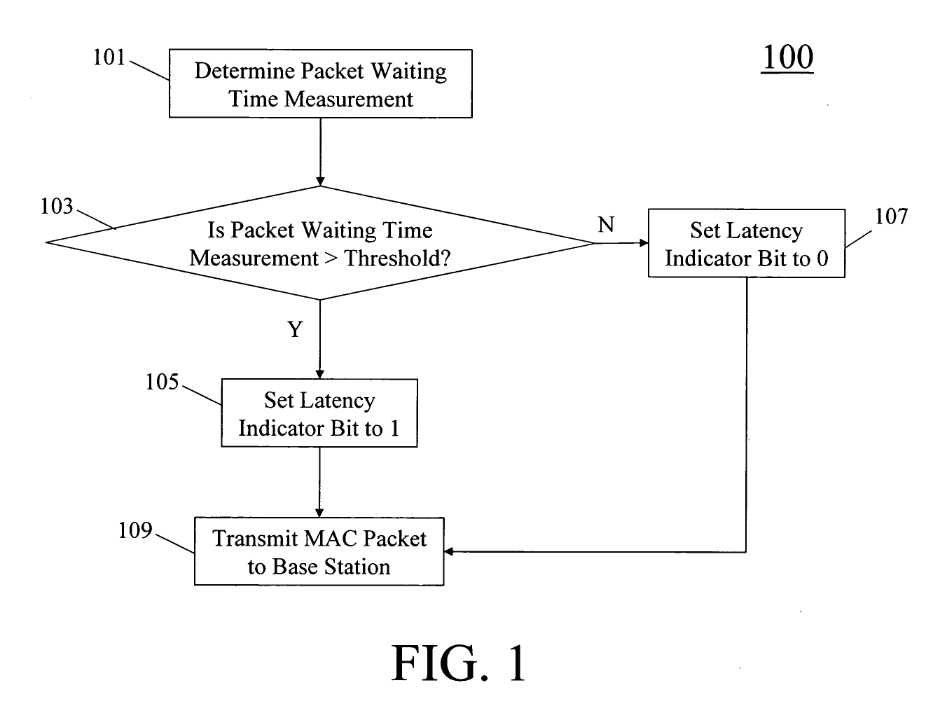

The present invention can be better understood with reference to FIGS. 1-4.

FIG. 1 depicts a flowchart 100 of a method for transmitting a packet waiting time measurement from a mobile unit to a base station utilizing a latency indicator bit in accordance with an exemplary embodiment of the present invention. In this embodiment, the latency indicator indicates whether the packet waiting time has exceeded a predetermined delay threshold.

The mobile unit determines (101) a packet waiting time measurement. The packet waiting time measurement corresponds to the time that the oldest packet has been waiting in the buffer of the mobile unit without being acknowledged by a base station.

The mobile unit determines (103) if the packet waiting time measurement is greater than a predetermined threshold. In an exemplary embodiment, the delay threshold is related to the particular Quality of Service (QoS) requirements of the traffic on the flow.

The predetermined delay threshold is preferably determined by the network separately for each data flow in which the network has requested a latency indicator to be sent. The predetermined delay threshold is preferably signaled by the network to the mobile unit at call setup. In this case, the latency indicator for each data flow configured with a latency indicator is represented by a single bit. As an example, the bit is set to “1” if the packet waiting time has exceeded the predetermined delay threshold for that flow, and is set to “0” otherwise.

The mobile unit sets (105) the latency indicator bit to “1” if the packet waiting time measurement exceeded the predetermined threshold in step 103. The mobile unit sets the latency indicator bit to “1” if the oldest unacknowledged data packet has been waiting in the buffer longer than the predetermined delay threshold. The latency indicator bit for each configured flow is preferably provided as part of the MAC header as well as reported in the scheduling information.

The mobile unit sets (107) the latency indicator bit to “0” if the packet waiting time measurement does not exceed the predetermined threshold in step 103.

The mobile unit transmits (109) the MAC packet to base station.

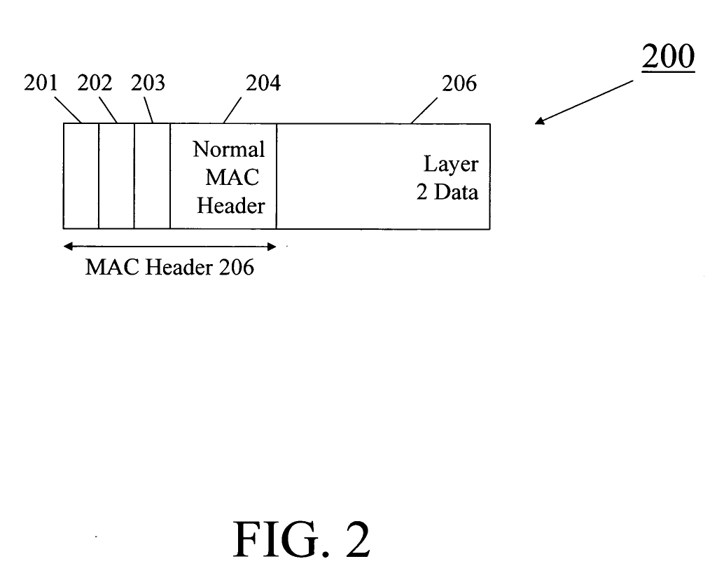

FIG. 2 depicts a representation of a MAC packet 200 in accordance with a first exemplary embodiment of the present invention. In the first exemplary embodiment, the latency indicator for each data flow configured with a latency indicator is sent as part of a MAC packet 200. MAC Packet 200 includes latency indicator bit 201, latency indicator bit 202, latency indicator bit 203, normal MAC header 204, and layer 2 data field 206. MAC header 206 comprises latency indicator bit 201, latency indicator bit 202, latency indicator bit 203, and normal MAC header 204.

In the case that there are multiple data flows configured at the mobile unit, such as VoIP and FTP, a latency indicator is provided for each data flow as configured by the network. The network may configure the mobile unit to provide a latency indicator for none, some, or all data flows. A first latency indicator is placed in latency indicator bit 201 and a second latency indicator is placed in latency indicator bit 202, for example.

The MAC header accompanies every data packet sent by the mobile unit. The MAC header typically includes a sequence number as well as information such as the number of data packets being carried in the MAC packet and from which data flows they are coming from in the mobile unit. In this exemplary embodiment, the latency indicator is sent as a single bit indicator, which keeps the overhead low in the MAC header. For example, if the network configured the mobile unit to report latency indicators for two different data flows, then only two bits would be added to the MAC header. The advantage of sending the latency indicator in the MAC header is that it allows the base station scheduler to obtain up-to-date latency information on the configured data flows in the mobile unit with every packet transmission by the mobile unit.

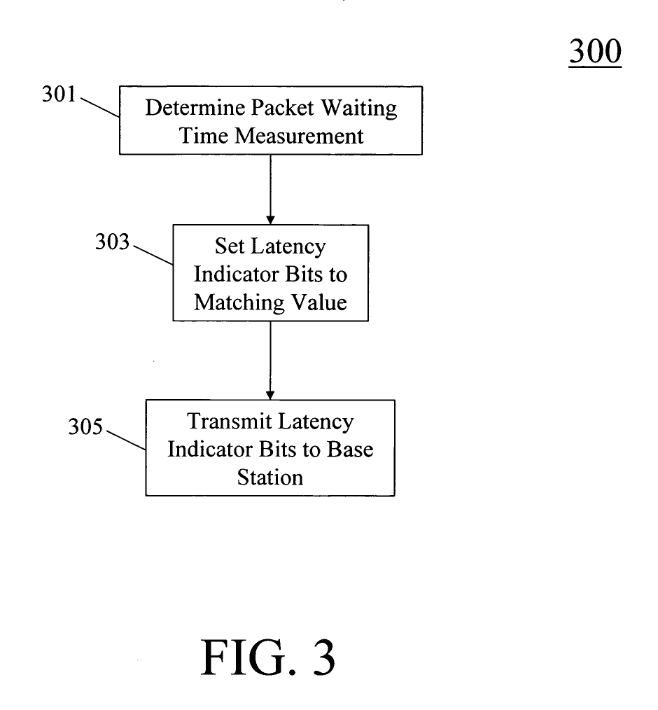

FIG. 3 depicts a flowchart 300 of a method for transmitting a packet waiting time measurement from a mobile unit to a base station using latency indicator bits in accordance with an exemplary embodiment of the present invention.

In the second exemplary embodiment, the latency indicator provides an absolute time measurement by the mobile unit of the packet waiting time. The time can be measured in any appropriate unit, such as milliseconds, slots (where a slot is defined as 0.5 milliseconds in LTE), or subframes (where a subframe is defined as 1 ms in LTE).

The mobile unit determines (301) a packet waiting time measurement. The packet waiting time measurement corresponds to the time that the oldest packet has been waiting in the buffer of the mobile unit without being acknowledged by a base station.

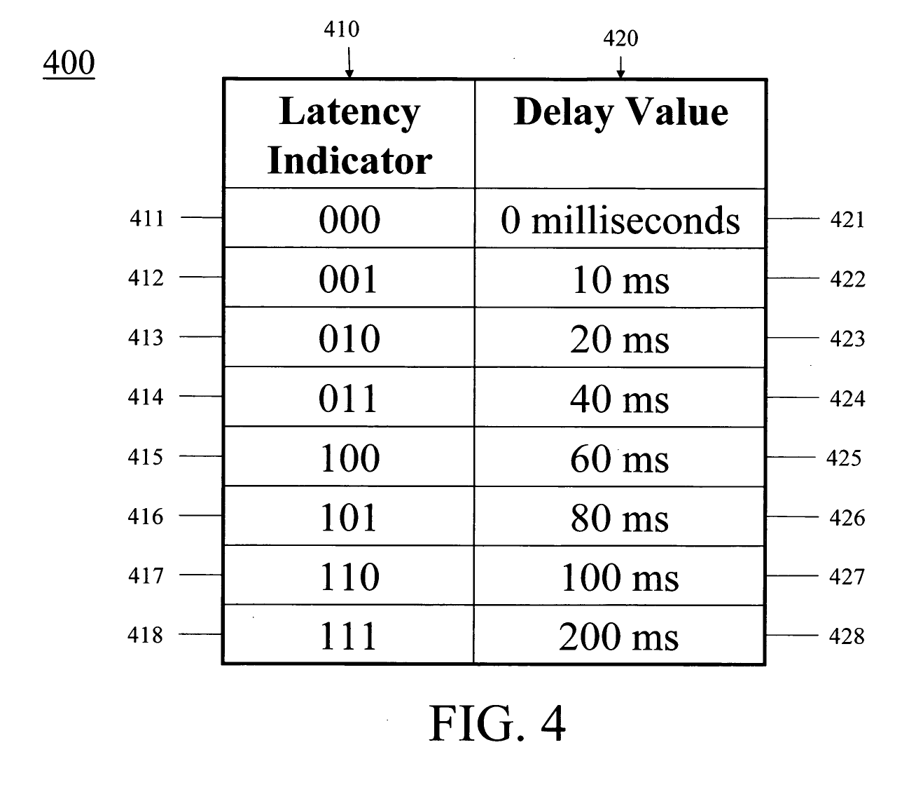

The mobile unit sets (303) latency indicator bits to a matching value. The values are shown in more detail in FIG. 4 below. Generally, the mobile unit assigns a latency indicator value to the oldest unacknowledged packet. The latency indicator preferably corresponds to a delay value, which can be in time units, such as milliseconds, slots, or any other suitable measurement. The mobile unit can assign the latency indicator bits to the closest delay value or the delay value that is closest to the actual waiting time without being greater than the actual waiting time.

The mobile unit transmits (305) the latency indicator bits to a base station.

FIG. 4 depicts a table 400 of representative latency indicator bits and delay values in accordance with an exemplary embodiment of the present invention. In this exemplary embodiment, several bits will be utilized to convey the delay information over an appropriate range. In the example depicted in FIG. 1, three bits are used to indicate the delay value. When three bits are used for the latency indicator, the network can assign eight values corresponding to these three bits. In the exemplary embodiment depicted in FIG. 4, latency indicator 411 has a value of “000” and corresponds to a delay value of 0 milliseconds, stored in field 421. Latency indicator 412 has a value of “001” and corresponds to a delay value of 10 milliseconds, stored in field 422. Latency indicator 413 has a value of “010” and corresponds to a delay value of 20 milliseconds, stored in field 423. Latency indicator 414 has a value of “011” and corresponds to a delay value of 40 milliseconds, stored in field 424. Latency indicator 415 has a value of “100” and corresponds to a delay value of 60 milliseconds, stored in field 425. Latency indicator 416 has a value of “101” and corresponds to a delay value of 80 milliseconds, stored in field 426. Latency indicator 417 has a value of “110” and corresponds to a delay value of 100 milliseconds, stored in field 427, Latency indicator 418 has a value of “111” and corresponds to a delay value of 200 milliseconds, stored in field 428. It should be understood that other values could be used in delay value field 420. Further, a different number of bits can be used in latency indicator field 410 to provide a greater or lesser amount of granularity. The more bits used, the greater number of delay values can be represented.

The mobile unit will choose a latency indicator corresponding to an absolute delay value which is either closest too or greater than packet waiting time. In an exemplary embodiment, the delay values are not uniformly spaced. The mapping between the latency indicator and the delay value can be arbitrarily defined by the network and a separate table can be signaled by the network to each mobile unit at initial call setup.

The present invention allows the base station scheduler to obtain relevant, up-to-date latency information on reverse link data flows. This allows for intelligent scheduling algorithms at the base station which account for packet delay. The latency indicator is particularly effective in scheduling the beginning of a talk spurt for voice over IP (VoIP) traffic, as well as enabling short round trip times for TCP traffic which improves best effort data throughput.

While this invention has been described in terms of certain examples thereof, it is not intended that it be limited to the above description, but rather only to the extent set forth in the claims that follow.

I claim:

1. A method comprising:
determining a packet waiting time measurement of an amount of time that a data packet has been waiting in a buffer of a mobile unit; and
transmitting the packet waiting time measurement to a base station.

2. A method in accordance with claim 1, wherein the data packet is the oldest packet in the buffer of the mobile unit.

3. A method in accordance with claim 1, wherein the step of determining a packet waiting time measurement comprises comparing the amount of time to a predetermined threshold.

4. A method in accordance with claim 3, wherein the predetermined threshold relates to a desired Quality of Service (QoS).

5. A method in accordance with claim 1, wherein the step of determining a packet waiting time measurement comprises assigning a latency indicator value to the packet waiting time measurement.

6. A method in accordance with claim 1, wherein the step of transmitting the packet waiting time measurement comprises transmitting the packet waiting time measurement in a Scheduling Information report.

7. A method in accordance with claim 1, wherein the step of transmitting the packet waiting time measurement comprises transmitting the packet waiting time measurement in a MAC header.

8. A method in accordance with claim 7, the method further comprising the step of transmitting the packet waiting time measurement in a Scheduling Information report.

9. A method comprising:
determining a packet waiting time measurement of an amount of time that a data packet has been waiting in a buffer of a mobile unit;
setting a packet latency flag based upon the packet waiting time measurement; and
transmitting the packet latency flag to a base station.

10. A method in accordance with claim 9, wherein the step of setting a packet latency flag comprises setting the packet latency flag when the packet waiting time measurement exceeds a predetermined threshold.

11. A method for calculating Voice over IP (VoIP) packet arrival comprising:
receiving a packet waiting time measurement of an amount of time that a VoIP packet has been waiting in a buffer of a mobile unit; and
calculating when a next VoIP packet will arrive in the buffer of the mobile unit based at least in part upon the packet waiting time measurement.

12. A method for calculating Voice over IP (VoIP) packet arrival in accordance with claim 11, wherein the VoIP packet is an initial VoIP packet.

13. A method for calculating Voice over IP (VoIP) packet arrival in accordance with claim 11, the method further comprising the step of pre-allocating resources based on when the next VoIP packet will arrive.
